(19) United States
(12) Patent Application Publication
(10) Pub. No.: US 2025/0127361 A1
(43) Pub. Date: Apr. 24, 2025

(54) POSITION ARRIVAL SWITCH ASSEMBLY AND AUTOMATIC CLEANING APPARATUS

(71) Applicant: Beijing Roborock Technology Co., Ltd., Beijing (CN)

(72) Inventors: Pan CHENG, Beijing (CN); Xing LI, Beijing (CN); Dalin OUYANG, Beijing (CN); Lvwu ZOU, Beijing (CN); Yungen QIN, Beijing (CN)

(21) Appl. No.: 18/689,215

(22) PCT Filed: Mar. 9, 2022
(86) PCT No.: PCT/CN2022/080008

§ 371 Date: Mar. 5, 2024

(30) Foreign Application Priority Data
Sep. 7, 2021 (CN) 202122150878.1

(51) Int. Cl. A47L 11/40; A47L 11/284

(52) U.S. Cl. CPC A47L 11/4008; A47L 11/284; A47L 11/4011; A47L 11/4083

(57) ABSTRACT

The position arrival switch assembly is assembled to the automatic cleaning apparatus, and is configured to indicate whether the automatic cleaning apparatus returns to a predetermined position of a pile body. The position arrival switch assembly includes: a switch component; a button, which is configured to move toward the switch component under the action of an external force; an elastic arm, which extends in a direction away from the button from the face of the button that faces the switch component; and a switch trigger piece, which is connected to the end of the elastic arm that is away from the button, wherein the switch component is configured to send a position arrival signal in response to being triggered by the switch trigger piece.

### CROSS-REFERENCE TO RELATED APPLICATIONS

This application is a national stage application under 35 U.S.C. § 371 of International Application No. PCT/CN2022/080008, filed on Mar. 9, 2022, which is claims the benefit of and priority to Chinese Patent Application No. 202122150878.1, filed on Sep. 7, 2021, the contents of both of which being incorporated by reference in their entireties herein as a part of the present application.

### TECHNICAL FIELD

The present disclosure relates to the field of cleaning robot technologies and, more particularly, to a position arrival switch assembly and an automatic cleaning apparatus.

### BACKGROUND

Automatic cleaning apparatuses are used to clean designated places automatically. Ground sweeping machines, ground mopping machines, ground sweeping and mopping integrated machines, and other automatic cleaning apparatuses are currently available. The automatic cleaning apparatus with a mopping function is equipped with a liquid storage tank to hold a cleaning liquid.

The automatic cleaning apparatus needs to return to a liquid supplementing pile for supplementing the cleaning liquid when the cleaning liquid in the liquid storage tank is insufficient. However, none of the existing automatic cleaning apparatuses has a position arrival indication apparatus to indicate whether the automatic cleaning apparatus travels to a predetermined position of the liquid supplementing pile, which may adversely affect a subsequent liquid supplementing process.

### BRIEF SUMMARY

The specific solutions are described below.

Some embodiments of the present disclosure provide a position arrival switch assembly, which is assembled on an automatic cleaning apparatus, that is configured to characterize whether the automatic cleaning apparatus returns to a predetermined position of a pile body, and includes:
a switch component;
a button, configured to move toward the switch component under the action of an external force;
an elastic arm, extending in a direction away from the button from, a face of the button that faces the switch component; and
a switch trigger piece, connected to the end of the elastic arm away from the button, wherein
the switch component is configured to send a position arrival signal in response to being triggered by the switch trigger piece.

In some embodiments, the switch component includes:
a switch component body; and
an elastic component, extending toward the button from the side face of the switch component body that faces the button, wherein
in response to movement of the button toward the switch component, the switch trigger piece squeezes the elastic component to enable the elastic component to be compressed; and in response to the elastic component being compressed by a predetermined amount, the switch component sends a position arrival signal.

In some embodiments, the position arrival switch assembly further includes:
a position limit member, arranged on the side of the switch component body that faces the button, and configured to block the switch trigger piece from continuously compressing the elastic component in response to the elastic component being compressed by the predetermined amount.

In some embodiments, the position arrival switch assembly further includes:
a slide rail, configured to support the switch trigger piece to enable the switch trigger piece to be slidable on the slide rail.

In some embodiments, the elastic arm is of a bending structure which includes a first end, a second end and a bending pail located between the first end and the second end; the first end is connected to the button; and the second end is connected to the switch trigger piece.

In some embodiments, the number of the elastic arms is at least two, and the at least two elastic arms are symmetrically arranged relative to the median line of the button.

In some embodiments, at least one raised structure is arranged on the top surface of the button.

In some embodiments, the button includes:
a pressing part;
a first sub-part, which is strip-shaped and arranged on the side of the pressing part that faces the switch component, wherein the middle part of the first sub-part is connected to the pressing part; and
a second sub-part and a third sub-part which extend toward the switch component in a direction substantially perpendicular to the first sub-part from two ends of the first sub-part, respectively, wherein
at least one of the second sub-part and the third sub-part is configured to slide on a guide rail along with the movement of the button.

In some embodiments, a compression spring is arranged between the end of the guide rail that is away from at least one of the second and third sub-parts and a free end of at least one of the second and third sub-parts.

Some embodiments of the present disclosure provide an automatic cleaning apparatus, which includes the position arrival switch assembly described in the aforementioned embodiments.

In some embodiments, the automatic cleaning apparatus includes:
a mobile platform, and
a liquid storage tank, detachably arranged in the mobile platform, wherein
the position arrival switch assembly is arranged on the side of the liquid storage tank that faces the bottom surface of the mobile platform.

In some embodiments, the mobile platform includes a forward portion and a rearward portion, and both the liquid storage tank and the position arrival switch assembly are arranged in the rearward portion.

In some embodiments, a slot is formed on a side wall of the mobile platform, and is located below the liquid storage tank; and the pressing part of the button is arranged in the slot.

### BRIEF DESCRIPTION OF THE DRAWINGS

The accompanying drawings here, which are incorporated in the Description and constitute a part of the Description, show embodiments conforming to the present disclosure, and are used to explain the principles of the present disclosure together with the Description. Understandably, the accompanying drawings in the following description only show some embodiments of the present disclosure, and for those of ordinary skills in the art, other drawings may also be obtained from these accompanying drawings without creative efforts. In the accompanying drawings:

FIG. 1 is an oblique view of an automatic cleaning apparatus according to an embodiment of the present disclosure;

FIG. 2 is a schematic structural diagram of the bottom of an automatic cleaning apparatus according to an embodiment of the present disclosure;

FIG. 3 is an exploded view of an automatic cleaning apparatus according to an embodiment of the present disclosure;

FIG. 4 is a structural diagram of a supporting platform of an automatic cleaning apparatus according to an embodiment of the present disclosure;

FIG. 5 is a structural diagram of a vibrating member of an automatic cleaning apparatus according to an embodiment of the present disclosure;

FIG. 6 is a structural diagram of a vibrating member according to an embodiment of the present disclosure;

FIG. 7 is a schematic structural diagram of the assembly of a cleaning substrate according to an embodiment of the present disclosure;

FIG. 8 is a structural diagram of a clean water pump driven by a motor according to an embodiment of the present disclosure;

FIG. 9 is a structural diagram of a lifting and lowering module driven by a motor according to an embodiment of the present disclosure;

FIG. 10 is an overall structural diagram of an automatic cleaning apparatus according to an embodiment of the present disclosure;

FIG. 11 is a structural diagram of a liquid storage tank according to an embodiment of the present disclosure;

FIG. 12 is a partial sectional view of a liquid storage tank according to an embodiment of the present disclosure;

FIG. 13 is a schematic structural diagram of a position arrival switch assembly according to an embodiment of the present disclosure; and

FIG. 14 is an enlarged view of a region M in FIG. 13.

### DETAILED DESCRIPTION

To make the objectives, technical solutions, and advantages of the present disclosure clearer, the present disclosure will be further described in detail below with reference to the accompanying drawings. It is understood that the described embodiments are only some, but not all of the embodiments of the present disclosure. All other embodiments obtained by those of ordinary skills in the art without creative efforts based on the embodiments in the present disclosure are within the protection scope of the present disclosure.

The terms used in the embodiments of the present disclosure are for the purpose of describing particular embodiments only and are not intended to limit the present disclosure. The singular forms “a/an”, “said”, and “the” used in the embodiments of the present disclosure and the appended claims are intended to include the plural forms as well, unless otherwise indicated clearly in the context. The term “a plurality of” generally includes at least two.

It is to be understood that, the term “and/or” used herein only describes an association relationship between associated objects, and indicates that there may be three kinds of relationships. For example, A and/or B may indicate three cases: A exists alone, A and B exist at the same time, and B exists alone. In addition, the character “/” herein generally indicates an “or” relationship between the contextual objects.

It is to be understood that, although the terms first, second, third, etc. may be used to describe in the embodiments of the present disclosure, these should not be limited to these terms. These terms are only used to distinguish. For example, “first” . . . may also be referred to as “second” without departing from the scope of the embodiments of the present disclosure. Similarly, “second” . . . may also be referred to as “first”.

It is also to be noted that, the terms “including”, “containing”, or any other variants are intended to cover the nonexclusive inclusion, such that a commodity or device including a series of elements includes not only those elements, but also other elements not listed explicitly or elements inherent to such a commodity or device. Without more limitations, the element defined by the phrase “including a . . . ” does not exclude the existence of other same elements in the commodity or device including the element.

Optional embodiments of the present disclosure are described in detail below with reference to the accompanying drawings.

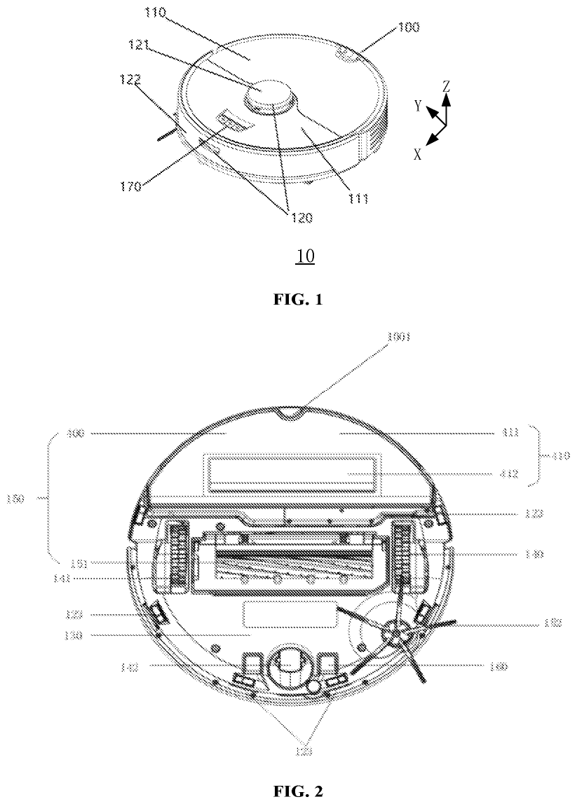

FIGS. 1 and 2 are schematic structural diagrams of an automatic cleaning apparatus according to an exemplary embodiment. As shown in FIGS. 1 and 2, the automatic cleaning apparatus 10 may be a vacuum ground sucking robot, or may be a ground mopping/brushing robot, or may be a window climbing robot, or the like. The automatic cleaning apparatus may include a mobile platform 100, a perception system 120, a control system 130, a driving system 140, a cleaning module 150, an energy system 160, and a human-computer interaction system 170.

The mobile platform 100 may be configured to move automatically along a target direction on an operating surface. The operating surface may be a surface to be cleaned by the automatic cleaning apparatus. In some embodiments, the automatic cleaning apparatus may be a ground mopping robot and, thus, the automatic cleaning apparatus operates on a ground, and the ground is the operating surface. The automatic cleaning apparatus may also be a window cleaning robot and, thus, the automatic cleaning apparatus operates on an outer surface of glass of a building, and the glass is the operating surface. The automatic cleaning apparatus may also be a pipe cleaning robot and, thus, the automatic cleaning apparatus operates on an inner surface of a pipe, and the inner surface of the pipe is the operating surface. For the purpose of presentation only, the following description in the present application takes a ground mopping robot as an example for illustration.

In some embodiments, the mobile platform 100 may be an autonomous mobile platform or a non-autonomous mobile platform. The autonomous mobile platform refers to that the mobile platform 100 itself can automatically and adaptively make an operational decision based on an unexpected environmental input. Also, the non-autonomous mobile platform itself cannot adaptively make an operational decision based on an unexpected environmental input, but can execute a given procedure or operate according to a certain logic. Correspondingly, when the mobile platform 100 is the autonomous mobile platform, the target direction may be determined autonomously by the automatic cleaning apparatus and, when the mobile platform 100 is the non-autonomous mobile platform, the target direction may be set systematically or manually. When the mobile platform 100 is the autonomous mobile platform, the mobile platform 100 includes a forward portion 111 and a rearward portion 110.

The perception system 120 includes a position determining device 121 located on the mobile platform 100, a buffer 122 located in the forward portion 111 of the mobile platform 100, cliff sensors 123 located at the bottom of the mobile platform, and sensing devices such as an ultrasonic sensor (not shown), an infrared sensor (not shown), a magnetometer (not shown), an accelerometer (not shown), a gyroscope (not shown), an odometer (not shown), and the like, for providing various position information and motion state information of the automatic cleaning apparatus to the control system 130.

In order to describe behaviors of the automatic cleaning apparatus more clearly, directions are defined as follows: the automatic cleaning apparatus may travel on the ground by various combinations of movements relative to the following three mutually perpendicular axes defined by the mobile platform 100, i.e., a transversal axis X, a front and rear axis Y and a center vertical axis Z. A forward driving direction along the front and rear axis Y is designated as “forward”, and a rearward driving direction along the front and rear axis Y is designated as “rearward”. The transversal axis X substantially extends between a right wheel and a left wheel of the automatic cleaning apparatus along an axis center defined by a center point of a driving wheel assembly 141. The automatic cleaning apparatus may rotate around the X axis. It is referred to as “pitch up” when the forward portion of the automatic cleaning apparatus is tilted upward and the rearward portion thereof is tilted downward, and it is referred to as “pitch down” when the forward portion of the automatic cleaning apparatus is tilted downward and the rearward portion thereof is tilted upward. In addition, the automatic cleaning apparatus may rotate around the Z axis. In a forward direction of the automatic cleaning apparatus, it is referred to as “turn right” when the automatic cleaning apparatus is tilted to the right of the Y axis, and it is referred to as “turn left” when the automatic cleaning apparatus is tilted to the left of the Y axis.

As shown in FIG. 2, cliff sensors 123 are provided at the bottom of the mobile platform 100 and in front and rear of the driving wheel assembly 141, respectively, and used for preventing the automatic cleaning apparatus from falling off when the automatic cleaning apparatus retreats, so as to avoid a damage to the automatic cleaning apparatus. The aforementioned “front” refers to a side the same as a travelling direction of the automatic cleaning apparatus, and the aforementioned “rear” refers to a side opposite to the travelling direction of the automatic cleaning apparatus.

The position determining device 121 includes, but is not limited to, a camera and a laser distance sensor (LDS).

Various components in the perception system 120 may operate independently, or operate together to achieve a purpose function more accurately. The surface to be cleaned is identified by the cliff sensors 123 and the ultrasonic sensor to determine physical properties of the surface to be cleaned, including a surface material, a degree of cleanliness, and the like, and may be determined more accurately in combination with the camera, the LDS, or the like.

For example, the ultrasonic sensor may determine whether the surface to be cleaned is a carpet. If the ultrasonic sensor determines that the surface to be cleaned is made of a carpet material, the control system 130 controls the automatic cleaning apparatus to perform cleaning in a carpet mode.

The forward portion 111 of the mobile platform 100 is provided with the buffer 122. During cleaning, when the driving wheel assembly 141 propels the automatic cleaning apparatus to travel on the ground, the buffer 122 detects one or more events (or objects) in a travelling path of the automatic cleaning apparatus via a sensor system, e.g., an infrared sensor, and the automatic cleaning apparatus may control the driving wheel assembly 141 based on the event (or object), such as obstacle and wall, detected by the buffer 122 to cause the automatic cleaning apparatus to respond to the event (or object), for example, to move away from the obstacle.

The control system 130 is disposed on a main circuit board in the mobile platform 100, and includes a computing processor such as a central processing unit and an application processor, that communicates with a non-transitory memory such as a hard disk, a flash memory and a random-access memory. The application processor is configured to receive environmental information sensed by the plurality of sensors and transmitted from the perception system 120, to draw a simultaneous map of an environment where the automatic cleaning apparatus is located using a positioning algorithm e.g., simultaneous localization and mapping (SLAM), based on obstacle information fed back by the LDS, and to autonomously determine a travelling path based on the environmental information and the environmental map, and then to control the driving system 140 to perform operations, such as travelling forward, travelling backward, and/or steering based on the autonomously determined travelling path. Further, the control system 130 may also determine whether to activate the cleaning module 150 to perform a cleaning operation based on the environmental information and the environmental map.

Specifically, the control system 130 may, based on distance information and speed information which are fed back by the buffer 122, the cliff sensors 123 and the sensing devices such as the ultrasonic sensor, the infrared sensor, the magnetometer, the accelerometer, the gyroscope and the odometer, comprehensively determine a current operation state of the ground sweeping robot, such as crossing a threshold, getting on a carpet, locating at an edge of a cliff, being stuck from above or below, having a full dust box or being picked up, and will also give specific next-step action strategies for different situations, so that the operation of the automatic cleaning apparatus is more in line with requirements of an owner and provides better user experience. Further, the control system can plan the most efficient and reasonable cleaning path and cleaning mode based on the simultaneous map drawn by the SLAM, thereby greatly improving the cleaning efficiency of the automatic cleaning apparatus.

The driving system 140 may execute a driving command based on specific distance and angle information, such as x, y, and 0 components, to manipulate the automatic cleaning apparatus to travel across the ground. As shown in FIG. 2, the driving system 140 includes the driving wheel assembly 141, and may control a left wheel and a right wheel simultaneously. In order to control the motion of the automatic cleaning apparatus more precisely, the driving system 140 optionally includes a left driving wheel assembly and a right driving wheel assembly. The left driving wheel assembly and the right driving wheel assembly are arranged symmetrically along a transversal axis defined by the mobile platform 100.

In order for the automatic cleaning apparatus to move on the ground more stably or have a stronger movement ability, the automatic cleaning apparatus may include one or more steering assemblies 142, wherein the steering assembly 142 may be a driven wheel or a driving wheel, and structurally includes but is not limited to a universal wheel. The steering assembly 142 may be located in front of the driving wheel assembly 141.

The driving motor 146 provides power for rotation of the driving wheel assembly 141 and/or the steering assembly 142.

The driving wheel assembly 141 may be detachably connected to the mobile platform 100 to facilitate assembly, disassembly and maintenance. The driving wheel may have an offset drop suspension system, which is movably fastened, e.g., rotatably attached, to the mobile platform 100 of the automatic cleaning apparatus, and maintain contact and traction with the ground by an elastic element such as a tension spring or a compression spring with a certain grounding force; meanwhile, the cleaning module 150 of the automatic cleaning apparatus is also in contact with the surface to be cleaned with a certain pressure.

The energy system 160 includes a rechargeable battery, such as a nickel-hydride battery and a lithium battery. The rechargeable battery may be connected with a charging control circuit, a battery pack charging temperature detecting circuit and a battery undervoltage monitoring circuit, wherein the charging control circuit, the battery pack charging temperature detecting circuit and the battery undervoltage monitoring circuit are then connected to a single-chip microcomputer control circuit. A host of the automatic cleaning apparatus is connected to a charging pile through a charging electrode arranged on a side of or below a body of the automatic cleaning apparatus for charging. If the exposed charging electrode is stained with dust, it will cause a plastic body around the electrode to melt and deform during charging due to an accumulative effect of an electric charge, or even cause the charging electrode itself to deform, so that normal charging cannot be continued.

The human-computer interaction system 170 includes buttons that are on a panel of the host and used by a user to select functions. The human-computer interaction system 170 may further include a display screen and/or an indicator light and/or a horn that present a current state or function item of the automatic cleaning apparatus to the user. The human-computer interaction system 170 may further include a mobile client program. For a route navigation type cleaning apparatus, a mobile client may present a map of the environment where the apparatus is located and a position of the apparatus to the user, which may provide richer and more user-friendly function items to the user.

The cleaning module 150 may include a dry cleaning module 151 and/or a wet cleaning module 400.

As shown in FIG. 2, the dry cleaning module 151 includes a rolling brush, a dust box, a blower and an air outlet. The rolling brush having a certain interference with the ground sweeps up garbage on the ground and rolls up the garbage to the front of a dust suction inlet between the rolling brush and the dust box, and then the garbage is sucked into the dust box by air having a suction force, which is generated by the blower and passes through the dust box. A dust removal capacity of the ground sweeping robot may be characterized by a dust pickup efficiency (DPU) of the garbage. The DPU is affected by a structure and material of the rolling brush, by a utilization rate of the air in an air channel formed by the dust suction inlet, the dust box, the blower, the air outlet and connecting components between them four, and by a type and power of the blower, which is a complex systematic design problem. Compared with an ordinary plug-in vacuum cleaner, the improvement of the dust removal capacity is more meaningful for an automatic cleaning apparatus with limited energy because the improvement of the dust removal capacity directly and effectively reduces requirements for energy, that is, the original cleaning apparatus that may clean 80 square meters of the ground on a single charge may be evolved to clean 180 square meters or more on a single charge. Furthermore, the service life of the battery with the reduced number of charging times will also be greatly increased, so that the frequency of replacing the battery by the user will also be decreased. More intuitively and importantly, the improvement of the dust removal capacity is the most apparent and important user experience, as the user will directly determine whether the thorough cleaning is achieved. The dry cleaning module may further include a side brush 152 having a rotary shaft, the rotary shaft is angled relative to the ground, for moving debris into a region of the rolling brush of the cleaning module 150.

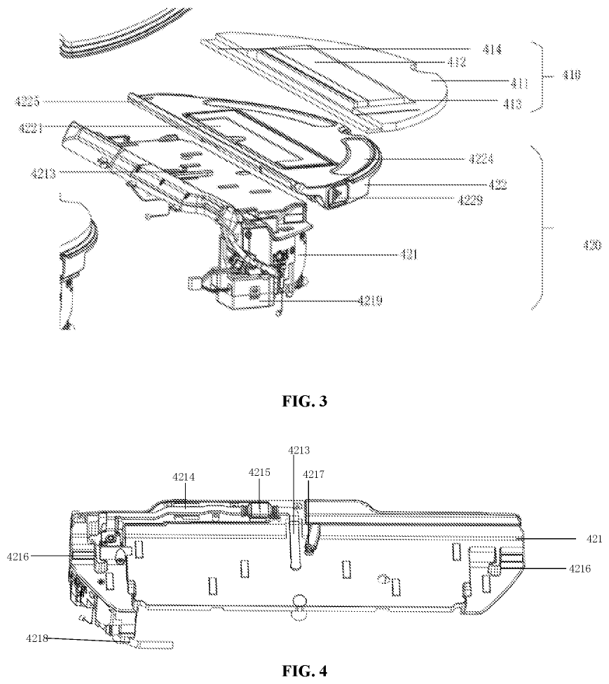

According to the specific embodiments of the present disclosure, as shown in FIGS. 3-5, the wet cleaning module 400 according to the present disclosure is configured to clean at least a part of the operating surface by means of wet cleaning. The wet cleaning module 400 includes a cleaning head 410 and a driving unit 420. The cleaning head 410 is used for cleaning at least a part of the operating surface, and the driving unit 420 is used for driving the cleaning head 410 to substantially reciprocate along a target surface, the target surface being a part of the operating surface. The cleaning head 410 reciprocates along a surface to be cleaned, and a surface of the cleaning head 410 in contact with the surface to be cleaned is provided with a piece of cleaning cloth or a cleaning plate, which generates high-frequency friction with the surface to be cleaned through the reciprocating motion, thereby removing stains on the surface to be cleaned.

The higher the friction frequency is, the more the friction times per unit time is. A high-frequency reciprocating motion, also referred to as reciprocating vibration, has a much higher cleaning ability than an ordinary reciprocating motion, e.g., rotational friction cleaning. Optionally, when the friction frequency approaches a sound wave, a cleaning effect will be much higher than that of the rotational friction cleaning of dozens of revolutions per minute. On the other hand, tufts on the surface of the cleaning head are more uniform and extend in the same direction under the shaking of high-frequency vibration so as to achieve a more uniform overall cleaning effect, rather than being only applied with a down pressure to increase the frictional force in the case of low-frequency rotation so as to improve the cleaning effect, as only the down pressure does not cause the tufts to extend in the nearly same direction. Therefore, in terms of the effect, water marks on the operating surface cleaned under the high-frequency vibration are more uniform, without leaving chaotic water stains.

The reciprocating motion may be a repeated motion along any one or more directions within the operating surface, or may be a vibrating motion perpendicular to the operating surface, which is not strictly limited. Optionally, the direction of the reciprocating motion of the cleaning module is substantially perpendicular to the travelling direction of the automatic cleaning apparatus because the direction of the reciprocating motion parallel to the travelling direction of the automatic cleaning apparatus may cause the travelling automatic cleaning apparatus unstable, for the reason that thrust and resistance in the travelling direction make the driving wheel likely to skid, and the effect of skid is more apparent when the wet cleaning module is included, as the wetness of the operating surface increases the possibility of skid. The skid not only affects the stable travelling of the automatic cleaning apparatus for cleaning, but also causes the sensors such as the odometer and the gyroscope to measure a distance inaccurately, thereby resulting in the inability of the navigation type automatic cleaning apparatus to locate and draw a map accurately. In the case of frequent skid, the effect on the SLAM cannot be ignored. Therefore, it is necessary to avoid the skid of the automatic cleaning apparatus as much as possible. In addition to skid, a motion component of the cleaning head in the travelling direction of the automatic cleaning apparatus causes the automatic cleaning apparatus to be pushed forward and backward constantly during travelling, so the automatic cleaning apparatus cannot travel stably and smoothly.

As an optional embodiment of the present disclosure, as shown in FIG. 3, the driving unit 420 includes: a driving platform 421 connected to the bottom surface of the mobile platform 100 and used for providing a driving force; and a supporting platform 422 detachably connected to the driving platform 421, used for supporting the cleaning head 410 and being able to lift and lower under the driving of the driving platform 421.

As an optional embodiment of the present disclosure, a lifting and lowering module is provided between the cleaning module 150 and the mobile platform 100, so that the cleaning module 150 may be in better contact with the surface to be cleaned, or different cleaning strategies may be used for surfaces to be cleaned made of different materials.

Optionally, the dry cleaning module 151 may be connected to the mobile platform 100 by a passive lifting and lowering module. When the cleaning apparatus encounters an obstacle, the dry cleaning module 151 may pass the obstacle more easily through the lifting and lowering module.

Optionally, the wet cleaning module 400 may be connected to the mobile platform 100 by an active lifting and lowering module. When the wet cleaning module 400 does not participate in the operation temporarily, or when a surface to be cleaned cannot be cleaned by the wet cleaning module 400, the wet cleaning module 400 is lifted by the active lifting and lowering module and separated from the surface to be cleaned, so as to realize the change of cleaning means.

As shown in FIGS. 4 and 5, the driving platform 421 includes: a motor 4211 arranged on the side of the driving platform 421 that faces the mobile platform 100 and used for outputting power through a motor output shaft; a driving wheel 4212 connected to the motor output shaft and being of an asymmetric structure; and a vibrating member 4213 arranged on a side of the driving platform 421 opposite to the motor 4211 and connected to the driving wheel 4212 to reciprocate under the asymmetrical rotation of the driving wheel 4212.

The driving platform 421 may further include a gear mechanism. The gear mechanism may connect the motor 4211 and the driving wheel 4212. The motor 4211 may directly drive the driving wheel 4212 to swivel, or may indirectly drive the driving wheel 4212 to swivel through the gear mechanism. Those of ordinary skills in the art may understand that the gear mechanism may be one gear, or may be a gear set composed of a plurality of gears.

The motor 4211 simultaneously transmits, through a power transmission device, power to the cleaning head 410, the driving platform 421, the supporting platform 422, a water delivery mechanism, a liquid storage tank, and the like. The energy system 160 provides power and energy for the motor 4211 and is entirely controlled by the control system 130. The power transmission device may be gear drive, chain drive, belt drive, or may be a worm gear, or the like.

The motor 4211 has a forward output mode and a reverse output mode. In the forward output mode, the motor 4211 rotates in the forward direction; and in the reverse output mode, the motor 4211 rotates in the reverse direction. In the forward output mode of the motor 4211, the motor 4211 simultaneously drives, through the power transmission device, the vibrating member 4213 of the driving platform in the wet cleaning assembly 400 to substantially reciprocate and the water delivery mechanism to move synchronously. In the reverse output mode of the motor 4211, the motor 4211 drives the driving platform 421 to lift and lower through the power transmission device.

Further, the driving platform 421 further includes a connecting rod 4214 extending along an edge of the driving platform 421 and connecting the driving wheel 4212 and the vibrating member 4213, so that the vibrating member 4213 extends to a preset position. An extension direction of the vibrating member 4213 is perpendicular to the connecting rod 4214, so that a reciprocating motion direction of the vibrating member 4213 is substantially perpendicular to the travelling direction of the automatic cleaning apparatus.

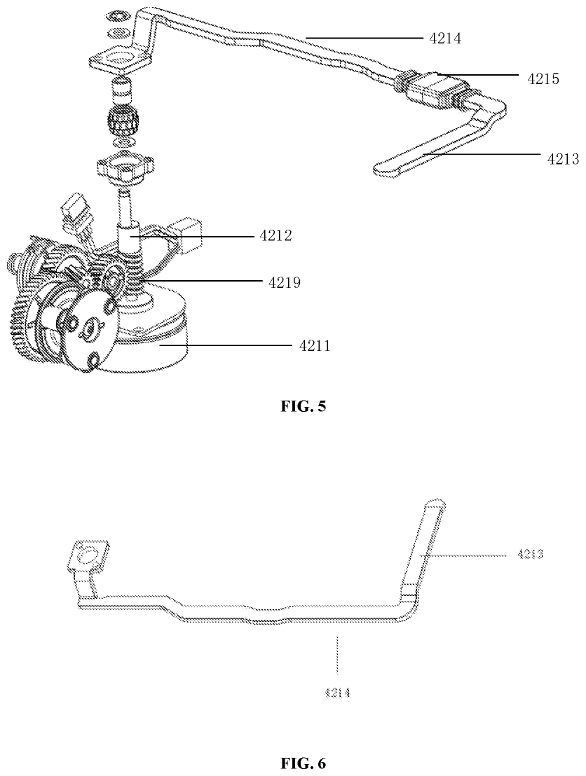

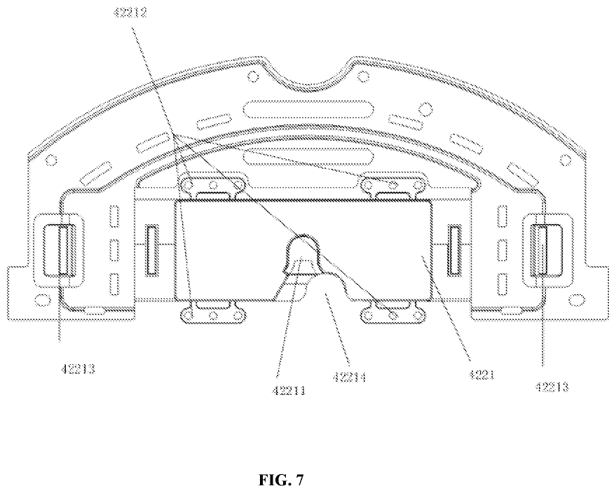

The motor 4211 is connected to the driving wheel 4212, the vibrating member 4213, the connecting rod 4214 and a vibration buffering device 4215 through the power transmission device. The vibrating member 4213 and the connecting rod 4214 constitute an approximate L-shaped structure, as shown in FIG. 6. The vibrating member 4213 reciprocates under the driving of the connecting rod 4214. The vibration buffering device 4215 has functions of damping and reducing the shaking of a motion behavior driven by the driving wheel 4212, so that the vibrating member 4213 may vibrate stably within a range of motion provided by the supporting platform 422. Optionally, the vibration buffering device 4215 is made of a soft material, optionally a rubber structure, and the vibration buffering device 4215 sleeves the connecting rod 4214. On the other hand, the vibration buffering device 4215 may also protect the vibrating member 4213 from being damaged due to the collision with the driving platform 421, and thus may also affect the reciprocating motion of the vibrating member 4213. Movable components and fixed components of the driving platform 421 are restricted from moving in the travelling direction of the automatic cleaning apparatus through connection with small elasticity, and are connected flexibly and allowed to move in the direction substantially perpendicular to the travelling direction, namely, in a vibration direction of the vibrating member 4213. The above two movement restrictions cause the vibrating member 4213 to substantially reciprocate rather than accurately reciprocate. When the wet cleaning assembly 400 is activated, the motor 4211 is started to rotate forward to drive the connecting rod 4214 through the driving wheel 4212 to reciprocate along the surface of the driving platform 421; meanwhile, the vibration buffering device 4215 drives the vibrating member 4213 to substantially reciprocate along the surface of the driving platform 421, the vibrating member 4213 drives a cleaning substrate 4221 to substantially reciprocate along the surface of the supporting platform 422, and the cleaning substrate 4221 drives a movable region 412 to substantially reciprocate along the surface to be cleaned. At this time, a clean water pump enables clean water to flow out of a clean water storage tank and the clean water is sprinkled on the cleaning head 410 through a water discharging device 4217, and the cleaning head 410 reciprocates to clean the surface to be cleaned.

The cleaning intensity/efficiency of the automatic cleaning apparatus may also be automatically and dynamically adjusted according to an operation environment of the automatic cleaning apparatus. For example, the automatic cleaning apparatus may achieve dynamic adjustment according to physical information of the surface to be cleaned detected by the perception system 120. For example, the perception system 120 may detect the flatness of the surface to be cleaned, a material of the surface to be cleaned, the existence of oil and dust, and other information, and transmit the information to the control system 130 of the automatic cleaning apparatus. Correspondingly, the control system 130 may instruct the automatic cleaning apparatus to automatically and dynamically adjust a rotational speed of the motor and a transmission ratio of the power transmission device according to the operation environment of the automatic cleaning apparatus, so as to adjust a preset reciprocating period of the reciprocating motion of the cleaning head 410.

For example, when the automatic cleaning apparatus operates on a flat ground, the preset reciprocating period may be automatically and dynamically adjusted to be longer, and a water volume of the water pump may be automatically and dynamically adjusted to be smaller; and when the automatic cleaning apparatus operates on a less flat ground, the preset reciprocating period may be automatically and dynamically adjusted to be shorter, and the water volume of the water pump may be automatically and dynamically adjusted to be larger. This is because it is easier to clean the flat ground than the less flat ground, and thus the reciprocating motion of the cleaning head 410 at a higher speed (i.e., a higher frequency) and in the larger water volume are needed for cleaning an uneven ground.

For another example, when the automatic cleaning apparatus operates on a table, the preset reciprocating period may be automatically and dynamically adjusted to be longer, and the water volume of the water pump may be automatically and dynamically adjusted to be smaller; and when the automatic cleaning apparatus 100 operates on a ground, the preset reciprocating period may be automatically and dynamically adjusted to be shorter, and the water volume of the water pump may be automatically and dynamically adjusted to be larger. This is because the table has less dust and oil compared with the ground, the material of the table is also easier to clean, and thus, the table can be cleaned with the fewer number of reciprocating motions of the cleaning head 410 and the relatively smaller water volume of the water pump.

As an optional embodiment of the present disclosure, the supporting platform 422 includes a cleaning substrate 4221 movably arranged on the supporting platform 422 and substantially reciprocating under the vibration of the vibrating member 4213. Optionally, as shown in FIG. 7, the cleaning substrate 4221 includes an assembly notch 42211 arranged at the position in contact with the vibrating member 4213. When the supporting platform 422 is connected to the driving platform 421, the vibrating member 4213 is assembled to the assembly notch 42211, so that the cleaning substrate 4221 can substantially reciprocate synchronously along with the vibrating member 4213. The cleaning substrate 4221 includes four first limiting positions 42212 in the travelling direction of the cleaning apparatus, and the four first limiting positions 42212 are flexibly connected to the cleaning substrate 4221 with a smaller elastic scaling space, thereby limiting the movement of the cleaning substrate 4221 in the travelling direction of the cleaning apparatus relative to the supporting platform 422. The cleaning substrate 4221 includes two second limiting portions 42213 in a direction perpendicular to the travelling direction of the cleaning apparatus, and the two second limiting positions 42213 limit a range of the reciprocating motion of the cleaning substrate 4221 in the direction perpendicular to the travelling direction of the cleaning apparatus. Furthermore, a water discharging hole 42214 is provided near the assembly notch 42211 of the cleaning substrate 4221, to enable water to flow from the water discharging device 4217 to the cleaning head 410 via the water discharging hole. The cleaning substrate 4221 substantially reciprocates due to the influence of the limiting positions and the vibration buffering device. The cleaning substrate 4221 is located in a portion of the supporting platform 422, and the vibration frequency may be made higher by means of local vibration, such as reaching a frequency range of the sound wave. The movable components and the fixed components of the driving platform 421 are restricted from moving in the travelling direction of the automatic cleaning apparatus through connection with small elasticity, and are connected flexibly and allowed to move in the direction substantially perpendicular to the travelling direction, namely, in the vibration direction of the vibrating member 4213.

Further, the supporting platform 422 further includes an elastic detaching button 4229 arranged on at least one side of the supporting platform 422 for detachably connecting the supporting platform 422 to pawls 4216 of the driving platform 421, so that the supporting platform 422 is detachably and mechanically fixed on the driving platform 421, and fixed relative to the driving platform and the automatic cleaning apparatus. At least one assembly region 4224 is arranged on the supporting platform 422 for assembling the cleaning head 410. The assembly region 4224 may be formed of an adhesive material with an adhesive layer.

As an optional embodiment of the present disclosure, as shown in FIG. 3, the cleaning head 410 includes a movable region 412 connected to the cleaning substrate 4221 to substantially reciprocate along the surface to be cleaned under the driving of the cleaning substrate 4221. The movable region 412 is arranged at a substantially central position of the cleaning head 410.

Optionally, an adhesive layer is provided on a side of the movable region 412 connected to the cleaning substrate 4221, and the movable region 412 is connected to the cleaning substrate 4221 through the adhesive layer.

Optionally, the cleaning head 410 further includes a fixed region 411 connected to the bottom of the supporting platform 422 through the at least one assembly region 4224. The fixed region 411 cleans at least a part of the operating surface along with the movement of the supporting platform 422.

Further, the cleaning head 410 further includes a flexible connecting portion 413 disposed between the fixed region 411 and the movable region 412 and used for connecting the fixed region 411 and the movable region 412. The cleaning head 410 further includes a sliding fastener 414 extending along an edge of the cleaning head 410 and detachably mounted at an engagement position 4225 of the supporting platform 422.

In the present embodiment, as shown in FIG. 3, the cleaning head 410 may be made of a material with certain elasticity, and is fixed to the surface of the supporting platform 422 through the adhesive layer so as to reciprocate. The cleaning head 410 is always in contact with the surface to be cleaned during operation.

The water delivery mechanism includes a water discharging device 4217 that may be directly or indirectly connected to a cleaning liquid outlet of a liquid storage tank (not shown), namely, a liquid outlet of the clean water storage tank. The cleaning liquid may flow to the water discharging device 4217 via the cleaning liquid outlet of the liquid storage tank, and the surface to be cleaned may be evenly coated with the cleaning liquid through the water discharging device. A connecting member (not shown) may be provided on the water discharging device, and the water discharging device is connected to the cleaning liquid outlet of the liquid storage tank through the connecting member. The water discharging device is provided with a distribution port which may be a continuous opening or a combination of several discontinuous small openings, and several nozzles may be provided at the distribution port. The cleaning liquid flows to the distribution port via the cleaning liquid outlet of the liquid storage tank and the connecting member of the water discharging device, and the operating surface is evenly coated with the cleaning liquid via the distribution port.

The water delivery mechanism may further include a clean water pump 4219 and/or a clean water pump pipe 4218. The clean water pump 4219 may be in direct communication with the cleaning liquid outlet of the liquid storage tank, or communication with the cleaning liquid outlet of the water tank through the clean water pump pipe 4218.

The clean water pump 4219 may be connected to the connecting member of the water discharging device, and configured to pump the cleaning liquid from the liquid storage tank to the water discharging device. The clean water pump may be a gear pump, a vane pump, a plunger pump, a peristaltic pump, or the like.

The water delivery mechanism draws the cleaning liquid out of the clean water storage tank through the clean water pump 4219 and the clean water pump pipe 4218, and transports the cleaning liquid to the water discharging device. The water discharging device 4217 may be a sprinkler head, a drip hole, a piece of wet cloth, or the like, and may uniformly spread water on the cleaning head, so as to wet the cleaning head and the surface to be cleaned. Stains on the wetted surface to be cleaned can be cleaned more easily. In the wet cleaning assembly 400, the power/flow rate of the clean water pump may be adjusted.

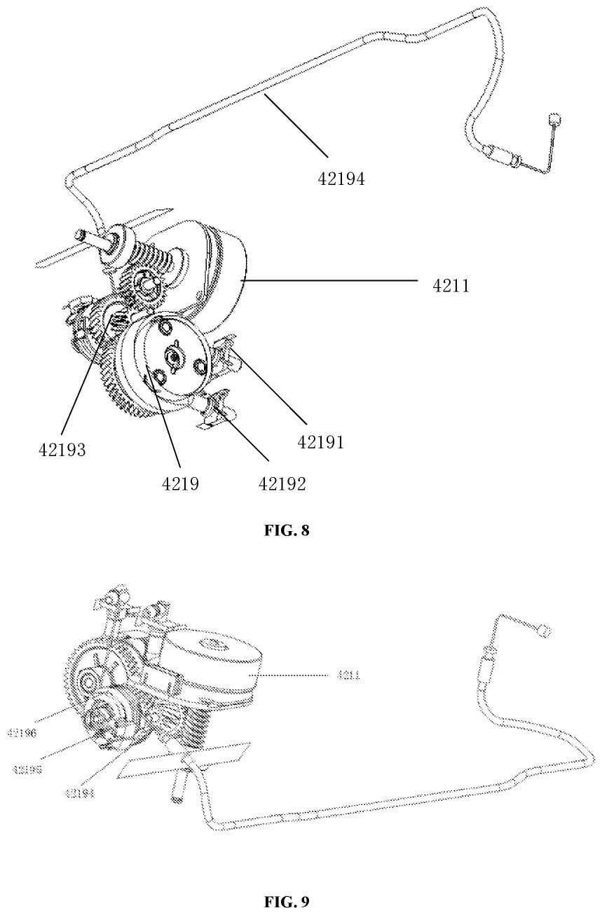

Further, as shown in FIG. 8, the motor 4211 drives the clean water pump 4219 to wriggle through a gear set 42193. Through the wriggle of the clean water pump 4219, the clean water enters from a water inlet 42191, flows out of a water outlet 42192, and is then transported to the water discharging device 4217 through the clean water pump pipe 4218. The water flowing out of the water discharging device 4217 flows to the cleaning head 410 via the water discharging hole.

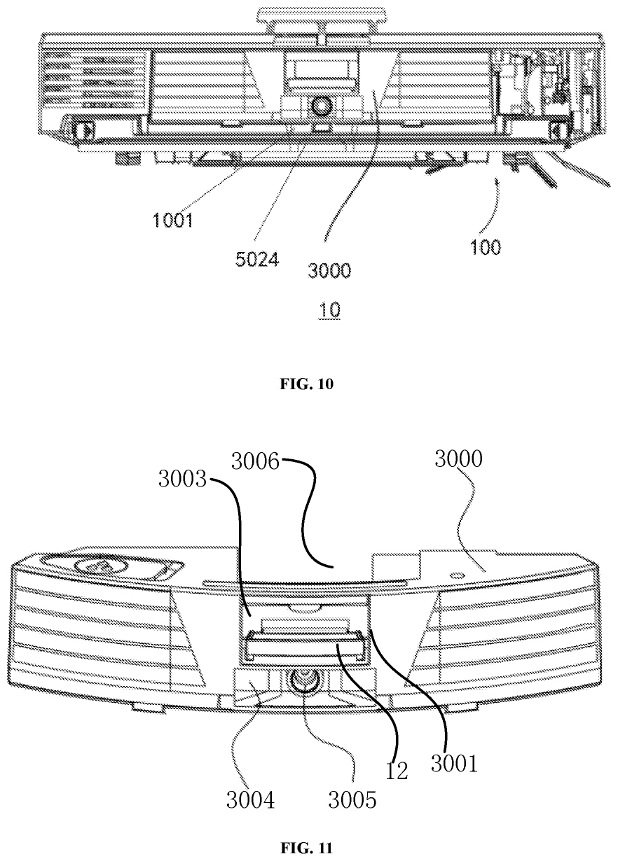

As shown in FIG. 9, the motor 4211 drives a cable gear 42196 to rotate through the gear set 42193. A cable 42194 is wound on the cable gear 42196, and is wound and suspended on the driving platform 421, and the cable gear 42196 pulls the cable 42194 to rise and drop so as to lift and lower the driving platform 421. The cable gear 42196 and the cable 42194 are core components of the lifting and lowering module.

A clutch 42195 is arranged on the gear set 42193 and the cable gear 42196, and includes a spring and a sheet-shaped member. By controlling the engagement and disengagement of the clutch 42195, the motor 4211 controls three motion modules, rotating in one direction to drive the vibrating member to vibrate and enable the clean water pump 4219 to supply water simultaneously; and rotating in an opposite direction to drive the lifting and lowering module to lift and lower through the cable 42194. Optionally, the combined design of the gear set realizes the control of the three motion modules in different combinations, for example, rotating the clean water pump in one direction to supply water, and rotating in the opposite direction to control the lifting and lowering and vibration. Optionally, two motors may also be used to control the three motion modules, but an extra motor also increases the cost.

Since the cleaning module of the automatic cleaning apparatus is provided with the dry cleaning module and the wet cleaning module, a more comprehensive cleaning function may be provided. Meanwhile, by adding the driving unit and the vibration region to the wet cleaning module, the cleaning head may reciprocate to repeatedly clean the surface to be cleaned. Therefore, in a movement trajectory of a cleaning robot, a region may be cleaned several times by the cleaning robot passing the region just one time, thereby greatly enhancing the cleaning effect. The cleaning effect is apparent especially for a region with many stains.

By cooperating with surface-type sensors such as surface medium sensors that can detect the type of the surface to be cleaned, the lifting and lowering module enables the wet cleaning module to perform cleaning operations based on different surfaces to be cleaned by, such as lifting the wet cleaning module on a carpet surface and lowering the wet cleaning module on a floor/tile surface and the like for cleaning, so as to achieve a more comprehensive cleaning effect.

In the embodiment of the present disclosure, the automatic cleaning apparatus 10 includes a liquid storage tank 3000, and the liquid storage tank 3000 further includes a liquid supplementing port 3005. As shown in FIGS. 10-12, the liquid supplementing port 3005 may be located on the side wall of the liquid storage tank 3000. A base station can inject a cleaning liquid into the liquid storage tank 3000 of the automatic cleaning apparatus 10 through the liquid supplementing port 3005 when the automatic cleaning apparatus 10 stops at the base station.

In the embodiment of the present disclosure, as shown in FIG. 11, the liquid storage tank 3000 is provided with a second assembly part 3004 which is used to be connected to the base station, so that the base station can inject the cleaning liquid into the liquid storage tank 3000 of the automatic cleaning apparatus 10 through the liquid supplementing port 3005. The second assembly part 3004 further includes the liquid supplementing port 3005 which is located at the approximate center of the second assembly part 3004 and used for allowing the cleaning liquid to be injected into the liquid storage tank 3000.

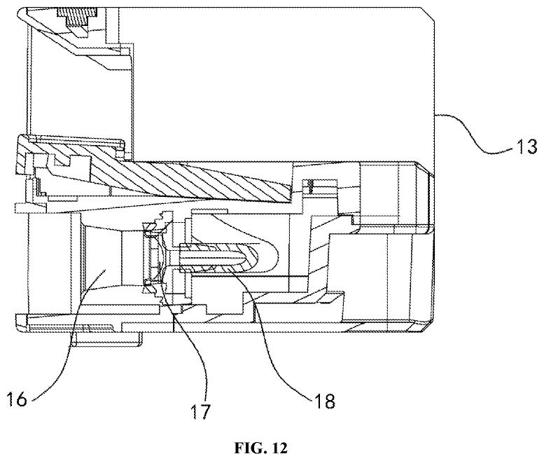

In the embodiment of the present disclosure, as shown in FIG. 12, a valve 17 is provided on the liquid supplementing port 3005 of the liquid storage tank 3000, and can be opened and closed to control the communication and disconnection between the liquid supplementing port 3005 and the liquid storage tank 3000. A pipeline 18 is arranged in the liquid storage tank 3000, and the valve 17 is arranged at one end of the pipeline 18.

In the embodiment of the present disclosure, the valve 17 may be an electronic valve or a manual valve, and it is ensured to be opened or closed by corresponding control. In other embodiments of the present disclosure, the valve 17 may also be a non-return valve. After the liquid supplement of the liquid storage tank 3000 is completed and the liquid supplementing port 3005 and the liquid storage tank 3000 are disconnected, the valve 17 is automatically closed to prevent the cleaning liquid in the liquid storage tank 3000 from flowing out. For example, the valve 17 may be a cross valve, a lift check valve, a swing check valve, etc.

In the embodiment of the present disclosure, in conjunction with FIGS. 2, 10 and 11, the liquid storage tank 3000 is arranged in the mobile platform 100 of the automatic cleaning apparatus 10. Specifically, the liquid storage tank 3000 is detachably arranged in the rearward portion 110 of the mobile platform 100. The side wall of the liquid storage tank 3000 constitutes a part of the side wall of the rearward portion 110. In the embodiment of the present disclosure, the automatic cleaning apparatus further includes a position arrival switch assembly. The position arrival switch assembly is configured to, for example, instruct the automatic cleaning apparatus 10 to return to a predetermined position of a liquid supplementing pile in an operation process in which the automatic cleaning apparatus returns to the liquid supplementing pile for supplementing a cleaning liquid, and send a position arrival signal to instruct the automatic cleaning apparatus 10 to perform a subsequent operation of supplementing the cleaning liquid.

The position arrival switch assembly is arranged in the mobile platform 100. Specifically, the position arrival switch assembly is arranged, for example, in the rearward portion 110, and is located on the side of the liquid storage tank 3000 that faces the bottom surface of the mobile platform 100.

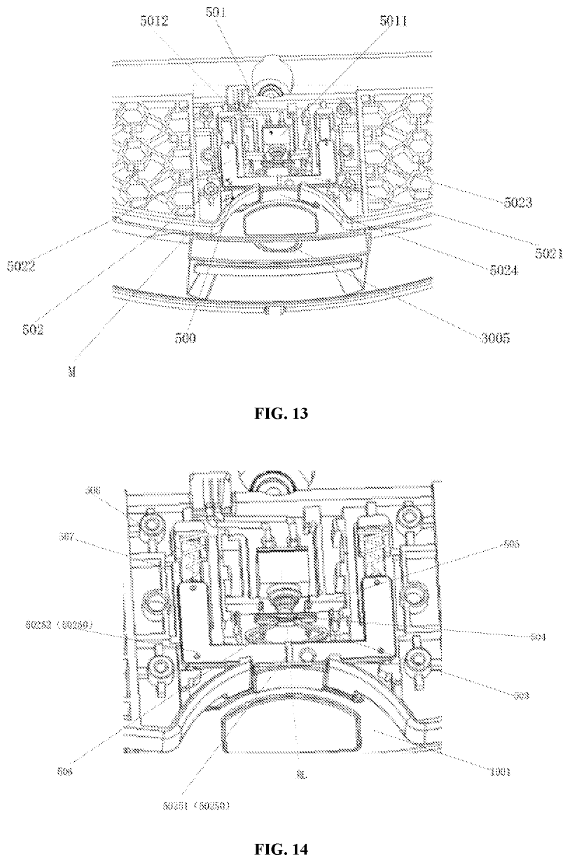

FIG. 13 is a schematic structural diagram of a position arrival switch assembly according to an embodiment of the present disclosure; and FIG. 14 is an enlarged view of a region M in FIG. 13. As shown in FIGS. 13 and 14, embodiments of the present disclosure provide a position arrival switch assembly 500, which is assembled on the automatic cleaning apparatus 10, and configured to characterize whether the automatic cleaning apparatus returns to a predetermined position of a pile body, such as a liquid supplementing pile.

The position arrival switch assembly 500 includes a switch component 501, a button 502, an elastic arm 503 and a switch trigger piece 504. The switch component 501 is fixed on, for example, the automatic cleaning apparatus 10, and sends a position arrival signal in response to being triggered by the switch trigger piece 504. Specifically, the switch component 501 is connected to other components through, for example, a circuit. In response to the switch component 504 being triggered by the switch trigger piece 504, the switch component 504 generates the position arrival signal and transmits the position arrival signal to the outside through the circuit. For example, the automatic cleaning apparatus 10 and/or the liquid supplementing pile may supplement cleaning liquid into the liquid storage tank 3000 of the automatic cleaning apparatus 10 in response to the position arrival signal.

The button 502 is configured to move toward the switch component 501 under the action of an external force. Specifically, in the operation process in which the automatic cleaning apparatus 10 returns to the liquid supplementing pile for supplementing the cleaning liquid, for example, in a process in which the automatic cleaning apparatus 10 gets on the pile, a protrusion on the liquid supplementing pile will be in contact with the button 502. As the automatic cleaning apparatus 10 further moves toward the liquid supplementing pile, the button 502 will move toward the switch component 501 under the pressing of the protrusion, that is, the external force is provided by the protrusion. In some embodiments, the automatic cleaning apparatus 10 returns to the liquid supplementing pile in a retreating manner, that is, the rearward portion 110 of the mobile platform 100 gets on the pile before the forward portion 111, which is determined by the positions of the liquid storage tank 3000 and the liquid supplementing port 3005. In some embodiments, the liquid storage tank 3000 is located in the rearward portion 110, and the liquid supplementing port 3005 is substantially located in the middle position of the rear end of the automatic cleaning apparatus 10.

The elastic arm 503 extends in a direction away from the button 502 from the side face of the button 502 toward the switch component 501, and is used to connect the button 502 and the switch trigger piece 504; and the switch trigger piece 504 is connected to the end of the elastic arm 503 away from the button 502. Under the action of the external force, the button 502 can push the switch trigger piece 504 to move toward the switch component 501, thereby realizing the triggering of the switch component 501.

In some embodiments, referring to FIGS. 13 and 14, the switch component 501 includes a switch component body 5011 and an elastic component 5012. The elastic component 5012 extends toward the button 502 from the side face of the switch component body 5021 that faces the button 502. The elastic component 5012 is, for example, generally conical, with its cone bottom and the switch component body 5011 and its cone tip pointing to the button 502.

In some embodiments, when there is no external force exerted on the button 50, that is, the button 502 is not pressed by the protrusion on the liquid supplementing pile, no force is exerted on the elastic component 5012 by a connection between the switch trigger piece 504 and the end of the elastic component 5012 that faces the button 502. With the automatic cleaning apparatus 10 getting on the pile, in response to the button 502 moving toward the switch component 501 under the action of the external force, the switch trigger piece 504 squeezes the elastic component 5012 to enable the elastic component 5012 to be compressed, that is, the end of the elastic component 5012 toward the button 502 moves toward the switch component body 5011 under the squeezing of the switch trigger piece, and at this time, the elastic arm 503 is also compressed.

In response to the elastic component 5012 being compressed by a predetermined amount, the switch component 501 generates and sends a position arrival signal to instruct the automatic cleaning apparatus 10 and/or the liquid supplementing pile to start to execute the step of supplementing the cleaning liquid. That is, after the end of the elastic component 5012 toward the button 502 moves toward the switch component body 5011 by a predetermined distance, the switch component 501 generates and sends the position arrival signal. It can be considered that the triggering of the switch component 501 by the switch trigger piece 504 is displacement triggering.

In some embodiments, as shown in FIGS. 13 and 14, the position arrival switch assembly 500 further includes a position limit member 505. The position limit member 505 is arranged on the side of the switch component body 5011 that faces the button 502, and configured to block the switch trigger piece 504 from continuously compressing the elastic component 5012 in response to the elastic component 5012 being compressed by the predetermined amount, so as to avoid the elastic component 502 from being damaged due to excessive compression. That is, the switch trigger piece 504 compresses the elastic component 5012 under the push of the button 502 until the switch trigger piece 504 reaches the position limit member 505 and is blocked by the position limit member 505. At this time, the compression by the elastic component 5012 just reaches the predetermined amount, and the switch component 501 is in the trigger state and sends out the position arrival signal.

Although the switch component 501 has already sent out the position arrival signal at this time, there may be an error between the position of the automatic cleaning apparatus and a preset position arrival position on the liquid supplementing pile. As the automatic cleaning apparatus 10 further gets on the pile, the button 502 further moves toward the switch component 501 under the action of the external force exerted by the protrusion. Since the switch trigger piece 504 is blocked by the position limit member 505, the elastic arm 503 is further compressed until the automatic cleaning apparatus 10 reaches its limit during getting on the pile. In this case, a button stroke after the switch component 501 is triggered is increased, and the robustness of the automatic cleaning apparatus reaching the predetermined position of the liquid supplementing pile is improved.

In some embodiments, as shown in FIGS. 13 and 14, the position arrival switch assembly further includes slide rails 506 configured to support the switch trigger piece 504 to enable the switch trigger piece 504 to be slidable on the slide rails. The number of slide rails 506 is, for example, two, and the two slide rails 506 extend in a moving direction of the button 502 to define the moving direction of the switch trigger piece 504.

In some embodiments, as shown in FIGS. 13 and 14, the elastic arm 503 is of a bending structure which includes a first end, a second end and a bending part located between the first end and the second end; the first end is connected to the button 502; and the second end is connected to the switch trigger piece 504. In other embodiments, the elastic arm also adopts other elastic structures, such as a telescopic arm.

In some embodiments, as shown in FIGS. 13 and 14, the number of the elastic arms 503 is, for example, two, and the two elastic arms 503 are symmetrically arranged with respect to the median line ML of the button 502. Specifically, the bending part of each of the two elastic arms 503 is further from the median line ML of the button 502 than the first and second ends of each of the two elastic arms 503.

In some embodiments, as shown in FIGS. 13 and 14, the top surface of the button 502 is provided with at least one raised part 5025, and a cover body on the bottom surface of the mobile platform 100 covers the position switch assembly. In FIGS. 13 and 14, in order to show the specific structural details of the position switch assembly, the cover body is not shown. The top surface of the button 502 refers to an approximately ␣-shaped surface of the button 502 shown in FIGS. 13 and 14, and faces the cover body. Generally, the button 502 will not be in contact with the cover body during its movement, but with the repeated movement and aging of the button 502, there is a risk that the button 502 will be deformed and thus rub against the cover body during its movement. In the present embodiment, by providing the raised part 5025, even if the button 502 is deformed during the movement, only the raised part 5025 is in contact with the cover body, avoiding abrasion to the button 502 and adverse influence on the movement of the button 502 which are caused by the friction between a relatively large region of the top surface of the button 502 and the cover body.

In some embodiments, as shown in FIGS. 13 and 14, the button 502 includes a pressing part 5024, a first sub-part 5021, a second sub-part 5022 and a third sub-part 5023. The pressing part 5024 is configured to be in contact with the protrusion and receive the external force that the protrusion presses the button 502.

The first sub-part 5021 is strip-shaped and is arranged on the side of the pressing part 5024 that faces the switch component 501. The middle part of the first sub-part 5021 is connected to the pressing part 5024. The first end of the elastic arm 503 is connected to the side face of the first sub-part 5021 that faces the switch component 501, and is substantially located near the middle position of this side face.

The second sub-part 5022 and the third sub-part 5023 extend toward the switch component 501 in a direction substantially perpendicular to the first sub-part 5021 from two ends of the first sub-part 5021, respectively. At least one of the second sub-part 5022 and the third sub-part 5023 is configured to slide on the guide rails 507 along with the movement of the button 502. The slide rails 507 extend in the moving direction of the button 502 and are configured to guide the button 502.

In some embodiments, as shown in FIGS. 13 and 14, the raised part 5025 includes a first raised part 50251 and second raised parts 50252. The first raised part 50251 is arranged in the middle position of the first sub-part 5021, is in the shape of, for example, a strip, and has a length direction parallel to the moving direction of the button 502. The second raised parts 50252 are arranged at two ends of the first sub-part 5021 as well as the ends of the second sub-part 5022 and the third sub-part 5023 that are away from the first sub-part 5021, and are each in the shape of a circle. It can be understood by those skilled in the art that the number, arrangement positions and shapes of the above first and second raised parts 50251 and 50252 are not limited to the embodiments shown in FIGS. 13 and 14.

In some embodiments, a compression spring 508 is arranged between the end of the guide rail 507 that is away from at least one of the second and third sub-parts 5022 and 5023 and a free end of at least one of the second and third sub-parts 5022 and 5023. The compression spring 508 is configured to enable the button 502 to return to its initial position in response to the disappearance of the external force exerted on the button 502. This avoids a problem of incomplete reset of the button 502 arising from resetting of the button 502 only by the elastic recovery of the elastic arm.

In some embodiments, the number of slide rails 507 is two, and the slide rails are used to guide the second sub-part 5022 and the third sub-part 5023, respectively.

Referring to FIGS. 2, 10, 11, 13, and 14, a slot 1001 is formed on a side wall of the mobile platform 100 of the automatic cleaning apparatus 10, and is located below the liquid storage tank 3000. The pressing part 5024 of the button 502 is arranged in the slot 1001, and is substantially located right under the liquid supplementing port 3005.

In some embodiments, the position arrival switch assembly 500 arranged in the mobile platform 100, specifically, in the rearward portion 110 is covered with the bottom surface of the mobile platform, instead of being exposed to the outside, so as to avoid an adverse effect on the position arrival signal caused by external interference.

In the position arrival switch assembly provided by the present disclosure, the position arrival switch assembly includes the elastic arm for connecting the button to the switch trigger piece, so that after the switch trigger piece moves to the position limit member and squeezes the elastic component of the switch component to trigger the switch component, the button can still move toward the switch component under the action of the external force due to the elasticity of the elastic arm. Therefore, a button stroke after the switch component is triggered is increased, and the robustness of the automatic cleaning apparatus reaching a predetermined position of a liquid supplementing pile is improved.

Finally, it should be noted that various embodiments in the Description are described in a progressive manner, each embodiment focuses on the differences from other embodiments, and the same or similar parts among the various embodiments may refer to one another. Since the system or device disclosed in the embodiment corresponds to the method disclosed in the embodiment, the description is relatively simple, and the relevant parts may refer to the description of the method part.

The above embodiments are only used to illustrate the technical solutions of the present disclosure and are not intended to limit the present disclosure. Although the present disclosure has been described in detail with reference to the foregoing embodiments, those of ordinary skills in the art should understand that, they can still make modifications to the technical solutions described in the foregoing embodiments or make equivalent substitutions to some of the technical features; and these modifications or substitutions do not make the essence of the corresponding technical solutions deviate from the spirit and scope of the technical solutions of the various embodiments of the present disclosure.

1. A position arrival switch assembly configured for use with an automatic cleaning apparatus and configured to determine whether the automatic cleaning apparatus is to return to a predetermined position of a pile body, the position arrival switch assembly comprising:
a switch component;
a button, configured to move toward the switch component under an action of an external force;
an elastic arm, extending in a direction away from the button from a face of the button that faces the switch component; and
a switch trigger piece, connected to an end of the elastic arm away from the button,
wherein the switch component is configured to send a position arrival signal in response to being triggered by the switch trigger piece.

2. The position arrival switch assembly according to claim 1, wherein the switch component comprises:
a switch component body; and
an elastic component, extending toward the button from a side face of the switch component body that faces the button,
wherein in response to movement of the button toward the switch component, the switch trigger piece squeezes the elastic component to enable the elastic component to be compressed; and in response to the elastic component being compressed by a predetermined amount, the switch component sends the position arrival signal.

3. The position arrival switch assembly according to claim 2, further comprising: a position limit member, arranged on a side of the switch component body that faces the button, and configured to block the switch trigger piece from continuously compressing the elastic component in response to the elastic component being compressed by the predetermined amount.

4. The position arrival switch assembly according to claim 1, further comprising: a slide rail, configured to support the switch trigger piece, such that the switch trigger piece is slidable on the slide rail.

5. The position arrival switch assembly according to claim 1, wherein the elastic arm is of a bending structure, the bending structure comprises a first end, a second end, and a bending part located between the first end and the second end; the first end is connected to the button; and the second end is connected to the switch trigger piece.

6. The position arrival switch assembly according to claim 1, wherein a quantity of the elastic arm is at least two, and the at least two elastic arms are symmetrically arranged relative to a median line of the button.

7. The position arrival switch assembly according to claim 1, wherein at least one raised structure is arranged on a top surface of the button.

8. The position arrival switch assembly according to claim 1, wherein the button comprises:
a pressing part;
a first sub-part, strip-shaped and arranged on a side of the pressing part that faces the switch component, wherein a middle part of the first sub-part is connected to the pressing part; and
a second sub-part and a third sub-part, extending toward the switch component in a direction substantially perpendicular to the first sub-part from two ends of the first sub-part, respectively,
wherein at least one of the second sub-part and the third sub-part is configured to slide on a guide rail along with movement of the button.

9. The position arrival switch assembly according to claim 8, wherein a compression spring is arranged between an end of the guide rail that is away from at least one of second sub-part and the third sub-part and a free end of at least one of the second sub-part and the third sub-part.

10. An automatic cleaning apparatus, comprising a position arrival switch assembly configured to determine whether the automatic cleaning apparatus is to return to a predetermined position of a pile body, and the position arrival switch assembly comprises:
a switch component;
a button, configured to move toward the switch component under an action of an external force;
an elastic arm, extending in a direction away from the button from a face of the button that faces the switch component; and
a switch trigger piece, connected to an end of the elastic arm away from the button,
wherein the switch component is configured to send a position arrival signal in response to being triggered by the switch trigger piece.

11. The automatic cleaning apparatus according to claim 10, comprising:
a mobile platform; and
a liquid storage tank, detachably arranged in the mobile platform,
wherein the position arrival switch assembly is arranged on a side of the liquid storage tank that faces a bottom surface of the mobile platform.

12. The automatic cleaning apparatus according to claim 11, wherein the mobile platform comprises a forward portion and a rearward portion, and both the liquid storage tank and the position arrival switch assembly are arranged in the rearward portion.

13. The automatic cleaning apparatus according to claim 11, wherein a slot is formed in a side wall of the mobile platform, and is located below the liquid storage tank; and the pressing part of the button is arranged in the slot.

14. A method, comprising:
providing a position arrival switch assembly configured for use with an automatic cleaning apparatus, the position arrival switch assembly being configured to determine whether the automatic cleaning apparatus is to return to a predetermined position of a pile body,
wherein the position arrival switch assembly comprises: a switch component; a button configured to move toward the switch component under an action of an external force; an elastic arm extending in a direction away from the button from a face of the button that faces the switch component; and a switch trigger piece connected to an end of the elastic arm away from the button, wherein the switch component is configured to send a position arrival signal in response to being triggered by the switch trigger piece.

15. The method according to claim 14, further comprising providing the automatic cleaning apparatus, wherein the position arrival switch assembly is arranged on the automatic cleaning apparatus.

16. The method according to claim 15, wherein the switch component comprises:
a switch component body; and
an elastic component, extending toward the button from a side face of the switch component body that faces the button,
wherein in response to movement of the button toward the switch component, the switch trigger piece squeezes the elastic component to enable the elastic component to be compressed; and in response to the elastic component being compressed by a predetermined amount, the switch component sends the position arrival signal.

17. The method according to claim 16, further comprising: a position limit member, arranged on a side of the switch component body that faces the button, and configured to block the switch trigger piece from continuously compressing the elastic component in response to the elastic component being compressed by the predetermined amount.

18. The method according to claim 15, further comprising: a slide rail, configured to support the switch trigger piece, such that the switch trigger piece is slidable on the slide rail.

19. The method according to claim 15, wherein the elastic arm is of a bending structure, the bending structure comprises a first end, a second end, and a bending part located between the first end and the second end; the first end is connected to the button; and the second end is connected to the switch trigger piece.

20. The method according to claim 15, wherein at least one raised structure is arranged on a top surface of the button.
